(19) United States
(12) Patent Application Publication
(10) Pub. No.: US 2011/0126650 A1
(43) Pub. Date: Jun. 2, 2011

(54) ACTUATOR, CHAIN AND METHOD OF USE

(75) Inventors: Jens Jorren Sorensen, Kobenhavn S (DK); Janus Juul Rasmussen, Helsinge (DK)

(73) Assignee: KATAKA A/S, Kobenhavn K (DK)

(21) Appl. No.: 12/991,619

(22) PCT Filed: May 8, 2008
(86) PCT No.: PCT/EP08/03697

§ 371 Date: Jan. 24, 2011

(51) Int. Cl. F16H 21/50; F16G 13/06; B23P 23/00

(52) U.S. Cl. 74/89; 59/84; 29/401.1

(57) ABSTRACT

An actuator includes a plurality of chain links that can be wound up to transform a chain of the links into a stable elongated rod protruding from the actuator and can be unwound to transform the elongated rod into a chain that is received in a chain magazine. The actuator is particularly compact and flat and can be placed in the relatively narrow spaces.

### BACKGROUND

1. Field

The present application relates to an actuator, in particularly to an actuator that has a very low building height in the actuation correction. Further, the application relates to a chain for use such an actuator especially a chain that is capable of transforming from a chain to a rod and vice versa.

2. Brief Description of Related Developments

WO 99/53221 discloses a method and apparatus for transfer of pressure and/or tensile load. The apparatus includes a chain with a plurality of chain links that are capable being wound up to interlock and form a spindle and vice versa.

The known method provides an elongate spindle member with high rigidity and stability against pressure and/or tensile load as well as bending and torsional load by winding-up of mutually interlocking chain links under axial displacement in a helical winding by means of a winding guide means connected with one of the two objects and a driving device. Further, a coupling member is provided for connection of the helical winding with the other of the two objects, and each chain link is retained in engagement with neighbouring links in the same turn as well as adjacent chain links in neighbouring turns.

By winding mutually interlocked chain links in this manner in a helical winding under active retainment of the individual chain links in their positions in the helical winding, it become possible to provide an actuator having significant stability against pressure and/or tensile loads as well as bending and torsional loads and which may act as a pressure bar or drawbar or torque shaft between two objects.

However, the known actuator is driven by an advancing wheel disposed concentrically inside the stem of the spindle and advancing of the rod is ensured by engagement of the spindle with an internal thread provided in the actuator housing. This internal thread is relatively expensive and difficult to produce. Further, approximately half of the axial load is carried by the drive wheel. This load on the drive wheel requires the use of large capacity roller bearings in order to provide an acceptable durability. However, there is only very little space available below the drive wheel and small roller bearings with a high load capacity are expensive. Further, the assembling procedure is complicated for a roller bearing located so centrally in the actuator.

### SUMMARY

On this background, it is an object of the present application to provide a device that overcomes or at least reduces the drawbacks indicated above.

This object is achieved by providing an actuator comprising a plurality of chain links that can be wound up to transform a chain of the links into a stable elongated rod protruding from the actuator and can be unwound to transform the elongated rod into a chain that is received in a chain magazine, the elongate rod having a non-circular circumference, and the actuator being configured to engage the non-circular circumference to impart rotation on the rod.

By engaging the rod externally, the axial load can be carried by a large diameter roller bearing and an off-the-shelf roller bearing will provide ample reliability and life expectancy. The load on the bearing is mostly radial, which is a result from the gear wheel engagement. The axial load plus a little axial friction load in the opposite direction from the drive ring is carried by the mandrel.

The actuator may comprise a drive ring with radially distributed inwardly projecting protrusions shaped and dimensioned to engage the axial grooves of the rod. Thus, the rod can be efficiently engaged for imparting rotation thereon.

Preferably, the base of the elongate rod is received inside the drive ring and the drive ring may be supported by a roller bearing that surrounds the base of the rod.

The rod can be a hollow internally threaded rod and the actuator may comprise a stationary externally threaded mandrel around which the chain elements rotate in one direction to engage to form the rod and rotate in a second opposite rotation to disengage to form the chain.

The side of the chain elements that forms the inner surface of the rod can be provided with thread that engages the externally threaded mandrel at the base of the rod.

The engagement of the external thread of the mandrels with the internal thread of the chain elements at the base of the rod causes axial movement of the rod when the rod is rotated.

The radially outer surface of the drive ring can be toothed so that the drive ring forms a gearwheel. Thus, an excellent interface for engaging a drive motor and transmission is provided.

The actuator may comprise an electrical drive motor that is operably connected to the drive ring.

The electrical drive motor can be operably connected to the drive ring via a transmission that includes at least one worm and one wormwheel.

An alternative to the worm/wormwheel can be spiroid or helical gearing, see itw.com. Note: I have added this at the end of the detailed description

The object of though is also achieved by providing an actuator comprising a plurality of chain links that can be wound up to transform a chain of the links into a stable elongate hollow internally threaded rod protruding from the actuator and can be unwound to transform the elongate rod into a chain that is received in a chain magazine, wherein the actuator comprises a stationary externally threaded mandrel around which the chain elements rotate in one direction to engage to form the rod and rotate in a second opposite rotation to disengage to form the chain.

By providing an externally threaded mandrel at the stem of the internally threaded rod the actuator can be constructed without an expensive and difficult to produce internal threat in the actuator housing. Thus, the actuator is less expensive and easier to manufacture.

Preferably, the mandrel is hollow and filled with lubrication that can reach the external thread on the mandrel via one or more location holes in the mandrel. Thus, the internal portion of the actuator can be lubricated for life.

The protruding portion of the external threat on the mandrel is relatively thin and the internal thread provided on the chain elements is relatively thick.

The chain can be made of a polymer material, preferably in engineering plastic and the externally threaded mandrel is made of a metal, preferably steel. Thus, with the metal treat being thin and the plastic thread being thick the strength and durability of the threaded engagement is balanced between the stronger and less strong material resulting in longer life expectancy.

A further aspect of the disclosed embodiments provides an actuator comprising a plurality of chain links that can be wound up to transform a chain of the links into a stable elongate rod protruding from the actuator and can be unwound to transform the elongate rod into a chain that is received in a chain magazine, wherein the chain elements are made from a polymer material.

By using polymer material as opposed to metal and relatively light and smooth running actuator is obtained.

Preferably the polymer material is an engineering plastic.

A further aspect of the disclosed embodiments provides an actuator comprising a plurality of chain links that can be wound up to transform a chain of the links into a stable elongate rod protruding from the actuator and can be unwound to transform the elongated rod into a chain that is received in a chain magazine, wherein the chain links are guided in a winding station that includes a slanting guide member provided with a slanting lower guide surface that engages the underside the chain links to displace the chain links relative to the subsequent chain links so that the chain adopts a slanted configuration during winding just before the chain links engage a helical guide that ensures that the chain adopts a circular and slanted or so called helical configuration.

Thus, the consecutive chain links can be arranged in the appropriate displaced configuration for and engaging the neighboring chain links in the rod without the need for special guide pins, or other protrusions to ensure the correct configuration of the consecutive chain links.

The slanting guide member can be provided with a slanting upper guide surface that engages the upper side of the chain links just after they exit the helical guide during unwinding to ensure that the chain links adopt a non-slanting configuration in the chain magazine.

An externally treaded mandrel may be concentrically received inside the helical guide.

The chain links can be guided in the chain magazine by the upper, lower, and side surfaces of the chain guide without the need for guide rails or guide pins.

Preferably, the rod is free of non-axial grooves

Another aspect of the disclosed embodiments provides an actuator comprising a plurality of chain links that can be wound up to transform a chain of the links into a stable elongate rod protruding from the actuator and can be unwound to transform the elongate rod into a flexible chain that is received in a chain magazine, wherein the chain magazine comprises two levels.

By splitting the magazine into two levels or more levels, or in a helix shaped container, it becomes possible to house a longer chain in a relatively small housing. An increased chain length results in an increased rod length and thereby an increased stroke for the actuator.

The chain magazine may comprise a section with chain path arranged in a first plane, a section chain path leading from the first plane to a second plane and a section with a chain path arranged in the second plain.

One aspect of the disclosed embodiments provides an end piece for a chain that comprises plurality of chain links that can be wound up and interlocked to transform the chain into a stable elongate rod and can be unwound to transform the elongate rod into a flexible chain, the end piece comprising a coupling member for connecting to the first chain link at the extremity of the chain and a spiral or circular and stepped engagement surface for engaging and interlocking with several of the chain links at the extremity of the chain.

Thus, the free extremity of the rod is provided with a suitable attachment and engagement surface for connecting to other equipment.

The end piece may further comprise an end surface forming the top of the elongated rod.

The end piece may further be provided with a rotary bearing configured to enable the end piece to be connected to another device whilst the rod can revolve about its longitudinal axis.

A further aspect of the disclosed embodiments provides a chain that comprises plurality of chain links that can be wound up and interlocked to transform the chain into a stable elongate rod and can be unwound to transform the elongate rod into a flexible chain, wherein the chain links have a substantially rectangular outline when viewed in a radial direction of the rod.

By giving the chain links a rectangular outline as opposed to a rhombic outline the guidance of the chain link in a chain magazine is significantly simplified. Thus, it is easier to manufacture the mould, and easier to check the dimensions of the molded chain link for quality control. The links are also easier to design in a 3D-CAD-program, which is an advantage when making variations.

Neighboring chain links are arranged displaced relative to one another when the chain is wound to form a rod and the chain neighboring chain links are aligned when they are received in a planar chain magazine.

Preferably, the chain links form a circular and stepped arrangement then they are wound and interlocked to form the elongated rod.

The chain links may comprise on their exterior side a straight engagement ledge along one edge of the chain link and a straight slot along the opposite edge of the chain link.

Another aspect of the disclosed embodiments provides an actuator comprising a plurality of chain links that can be wound up to transform a chain of the links into a stable elongate rod protruding from the actuator and can be unwound to transform the elongate rod into a flexible chain that is received in a chain magazine, wherein the actuator is provided with an automatic chain end stop system for both the winding and the unwinding direction.

Thus, the movement of the chain and the rod can be automatically stopped at the end of the ingoing and outgoing stroke

Preferably, the automatic chain end stop comprises at least one magnet and a hall sensor coupled to an electronic control system of the actuator.

Another aspect of the disclosed embodiments provides a use in a wheelchair of an actuator comprising a plurality of chain links that can be wound up to transform a chain of the links into a stable elongate rod protruding from the actuator and can be unwound to transform the elongate rod into a flexible chain that is received in a chain magazine.

The actuator may be used to raise and lower the seat of the wheelchair.

A further aspect of the disclosed embodiments provides a wheelchair with an actuator comprising a plurality of chain links that can be wound up to transform a chain of the links into a stable elongate rod protruding from the actuator and can be unwound to transform the elongate rod into a flexible chain that is received in a chain magazine, the actuator being disposed under the seat of the wheelchair and configured to raise and lower the seat of the wheelchair.

In a wheelchair there is very little space arranging an actuator with and has a sufficient stroke to accommodate the lowering and raising of the seat. Thus, by providing an actuator that has an exceptional hide to stroke relation it become significantly less complicated to construct a height adjustable seat in a wheelchair.

Another aspect of the disclosed embodiments provides a use in a kitchen unit of an actuator comprising a plurality of chain links that can be wound up to transform a chain of the links into a stable elongate rod protruding from the actuator and can be unwound to transform the elongate rod into a flexible chain that is received in a chain magazine.

Present-day kitchens typically have a work top up with a fixed height. This predetermined height suits only a range of size of users. Users falling outside that range have presently to accept an inadequate worktop height. By providing a kitchen unit with the inventive actuator, it is possible to provide a relatively inexpensive and simple to install raising and lowering system for kitchen units.

Another aspect of the disclosed embodiments provides a kitchen unit supported by a plurality of cabinets with a worktop with two or more actuators comprising a plurality of chain links that can be wound up to transform a chain of the links into a stable elongate rod protruding from the actuator and can be unwound to transform the elongate rod into a flexible chain that is received in a chain magazine,

Preferably, the actuators are configured to raise and lower the kitchen unit.

A further aspect of the disclosed embodiments provides a floor supported by a plurality of actuators comprising a plurality of chain links that can be wound up to transform a chain of the links into a stable elongate rod protruding from the actuator and can be unwound to transform the elongate rod into a flexible chain that is received in a chain magazine.

In one embodiment, the actuators are configured to raise and lower the floor.

The floor can be a theater floor or stage. The floor could be a chair for elderly people with a catapult seat that raises and tilts in one go. Hereto, the actuator can be combined with various tilt and lifting mechanisms, such as scissor mechanisms.

Another aspect of the disclosed embodiments provides a method for winding and unwinding a chain that comprises plurality of chain links that can be wound up and interlocked to transform the chain into a stable elongate rod and can be unwound to transform the elongate rod into a flexible chain, the method comprising:

winding or unwinding the chain elements about a short externally threaded stationary mandrel by engaging the outer surface of the rod and applying torque to the rod to impart rotation and thereby wind or unwind the chain.

Thus, the portion of the significant axial load that is transferred to the component that engages the rod internally is a stationary component and does not need to be supported by a roller bearing. The mandrel takes the total axial load and the axial friction load contribution from the drive ring. Thus, this construction does not require the application of high capacity roller bearings in a small space.

In one embodiment, the short externally threaded stationary mandrel is at least partially surrounded by a helical guide that urges the chain elements into and out of a helical configuration or stepped and circular configuration.

Another aspect of the disclosed embodiments provides a method for creating a rod formed by a chain that comprises plurality of chain links that can be wound up and interlocked to transform the chain into a stable elongate rod and can be unwound to transform the elongate rod into a flexible chain, the method comprising winding up the chain form set rod and permanently connecting chain links together.

The chain links may be permanently connected together by welding, brazing or applying adhesive.

In one embodiment, the inner side of the chain links is provided with portions of an internal threat that is formed inside the rod when it is assembled.

Another aspect of the disclosed embodiments provides a rod or spindle formed by winding up a chain that comprises plurality of chain links that can be wound up and interlocked to transform the chain into a stable elongate rod and permanently secure the chain links to one another.

Thus, a rod spindle in any desired length can be quickly produced from a stock of chain links.

The spindle may be provided with an internal or external thread.

Another aspect of the disclosed embodiments provides an actuator comprising a plurality of chain links that can be wound up to transform a chain of the links into a stable elongated rod protruding from the actuator and can be unwound to transform the elongated rod into a chain that is received in a chain magazine, wherein the chain magazine is a rotating chain magazine.

Further aspects, features, advantages and properties of the actuator, chain, rod or spindle, uses, wheelchair, teaching and floor according to the disclosed embodiments will become apparent from the detailed description.

### BRIEF DESCRIPTION OF THE DRAWINGS

In the following detailed portion of the present description, the aspects of the disclosed embodiments will be explained in more detail with reference to the exemplary embodiments shown in the drawings, in which:

FIG. 1 is an elevated view of the actuator according to an embodiment with the rod in a retracted position,

FIG. 2 is an elevated view of the actuator shown in FIG. 1 with the rod in an intermediate position,

FIG. 3 is an elevated view of the actuator shown in FIG. 1 with the rod in an extended position,

FIG. 4 is an elevated view of the actuator shown in FIG. 1 from another viewpoint,

FIG. 4a is a longitudinal sectional view through the actuator of FIG. 1,

FIG. 5 is a worked open elevated view of the actuator shown in FIG. 1,

FIG. 6 is a more worked open elevated view of the actuator shown in FIG. 1,

FIG. 7 is a worked open elevated view of the actuator shown in FIG. 1 from another viewpoint,

FIG. 8 is a worked open elevated view of the actuator shown in FIG. 1 in detail,

FIG. 9 is another worked open elevated view of the actuator shown in FIG. 1 in detail,

FIG. 10 shows elevated views of the actuator housing block as such,

FIG. 11 is an elevated view of the assembled housing block and associated components,

FIGS. 12a and 12b are detailed elevated views of a drive ring,

FIG. 13 is a detailed elevated view of the lower housing block with some of the associated transmission components,

FIGS. 14 to 16 are various views of a stationary threaded mandrel of the actuator of FIG. 1,

FIG. 17 is another detailed elevated view of the lower housing block with some of the associated transmission components,

FIG. 18 is a cross-sectional view through the center of the actuator of FIG. 1,

FIGS. 19 and 20 are different elevated views of a slanting chain guide of the of the actuator of FIG. 1,

FIG. 21 is another detailed elevated view of one of the housing blocks with some of the associated transmission components form another viewpoint,

FIG. 22 is an elevated worked open view of the transmission of the actuator according to FIG. 1,

FIG. 23 is another elevated worked open view of the transmission of the actuator according to FIG. 1 from another viewpoint,

FIG. 24 is a further worked open detailed view of the transmission of the actuator according to FIG. 1,

FIG. 25 is an exploded view all a shaft with a worm wheel that is connected to the electric drive motor,

FIGS. 26 to 28 show the slanted chain guide and the chain in greater detail,

FIG. 29 shows the winding of the chain from another side,

FIG. 30 shows the winding of the chain with the help of the slanting chain guide and around a stationary threaded mandrel in detail,

FIGS. 31 to 38 are various elevated views on chain links that are used in the actuator according to FIG. 1,

FIGS. 39 to 41 illustrate an end piece that is used to form the top of the rod/chain of the actuator shown in FIG. 1,

FIGS. 42 through 44 show a first embodiment of a swivel that is attached to the end piece shown in FIGS. 39 to 41,

FIGS. 45 and 46 show a second embodiment of the swivel of FIGS. 42 through 44, and

FIG. 47 shows another embodiment of the actuator according to the present disclosure.

### DETAILED DESCRIPTION OF THE DISCLOSED EMBODIMENTS

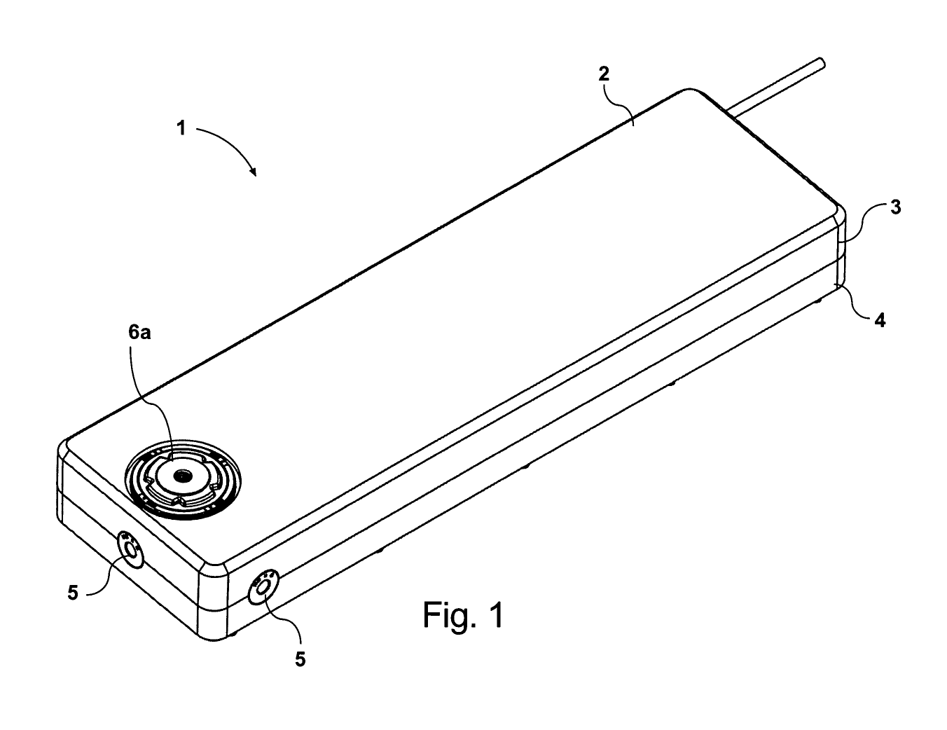

FIGS. 1 to 4 illustrate the actuator according to an aspect of the disclosed embodiments as elevation views. The actuator 1 comprises a housing 2 that is formed by a upper housing shell 3 and a lower housing shell 4. The housing shells can be made of plastic or metal by appropriate casting or molding techniques. The housing 2 is also provided with a plurality of attachment points 5 for connecting the house 1 to other equipment. In one embodiment, the attachment points are provided with a threaded recess.

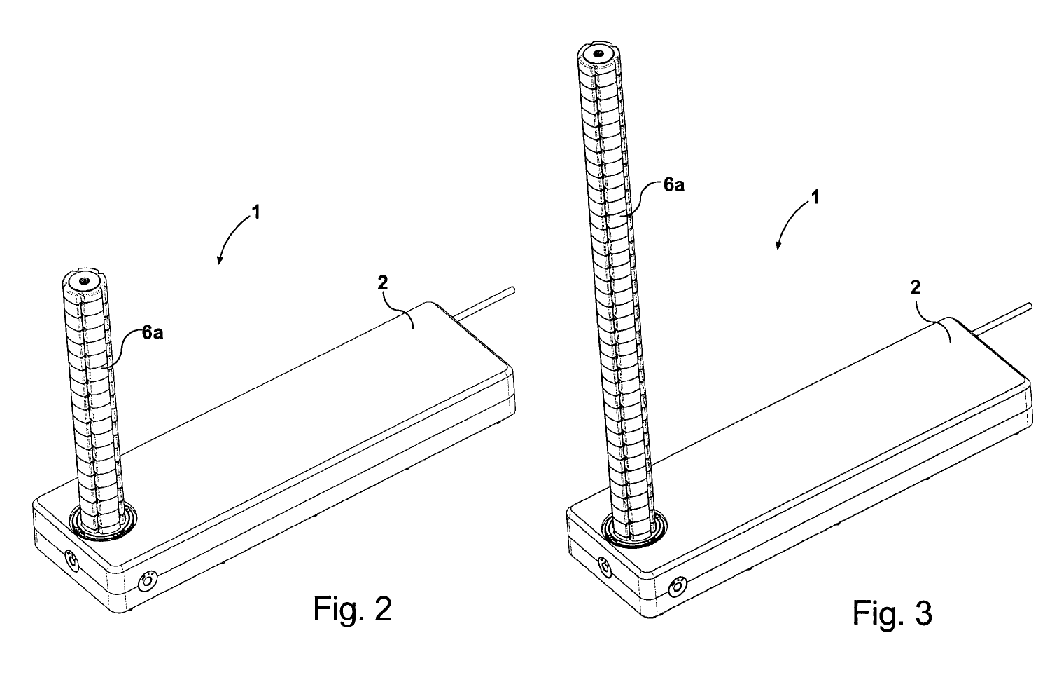

An actuating rod 6a that is formed from a plurality of chain links (as will be described in detail later on) can be completely retracted into the housing 2, as shown in figure and can be extended from the housing via a range of intermediate positions of which one is shown in FIG. 2 to a fully extended position shown in FIG. 3. A power cable is connected to the housing for providing power to an electric drive motor which will be described in greater detail later on. In the present embodiment the housing 2 is a flat cuboid, but any other flat housing form suitable for use in the aspects of the disclosed embodiments can be used, such as a disk shaped housing or a housing which has an oval or other shape that folds between a rectangular and a circular outline.

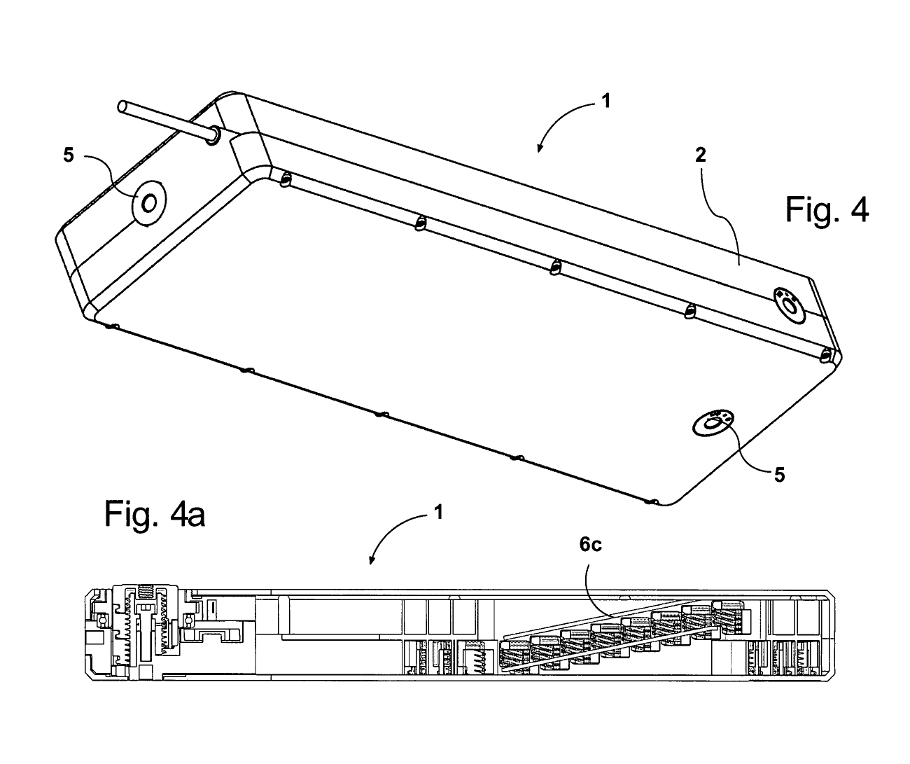

FIG. 4a is a longitudinal sectional view through the actuator 1 in which the various internal components of the actuator are visible. At this stage of the description this figure mainly serves to illustrate the transport of the chain from the lower level of the chain magazine 8 to the upper level of a duel level chain magazine 8. This transport is achieved by a slanting section 8a the chain magazine. The displacement of the chain links 6c is obtained by contact with the upper and lower surface of the chain link sides.

FIG. 5 is a cut open (the upper housing shell 3 has been removed) view of the actuator of FIG. 1. As can be seen in this cut open view, the actuator includes actuator block 7 at one end of the actuator to which an electric drive motor 9 is attached and a chain magazine 8, which is in this embodiment a dual layer chain magazine. The chain magazine 8 includes a substantially spiral path to wind up the chain in an effective manner in the chain magazine.

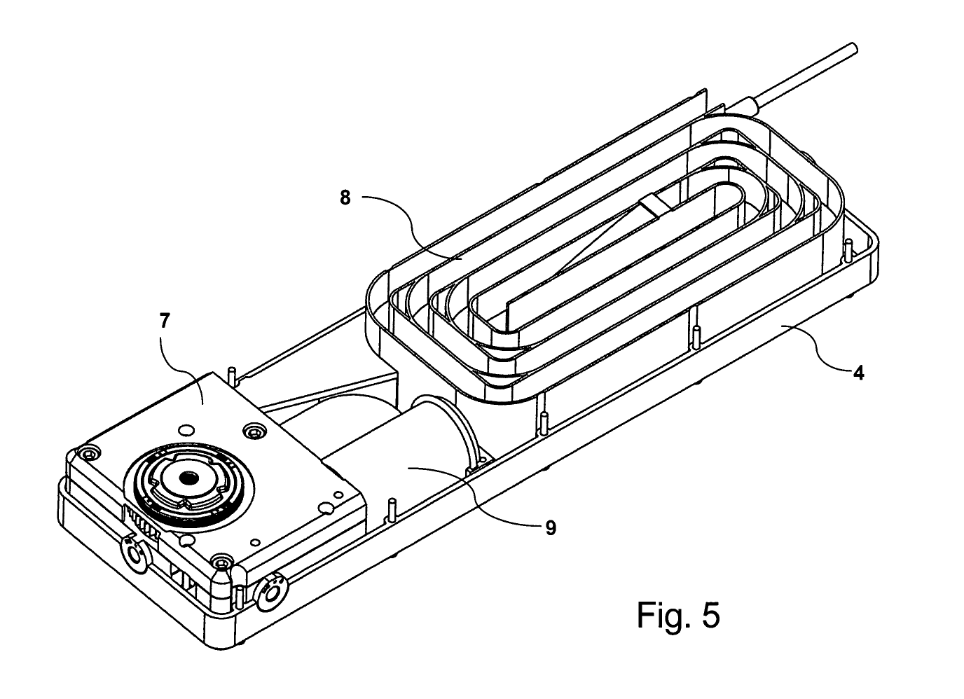

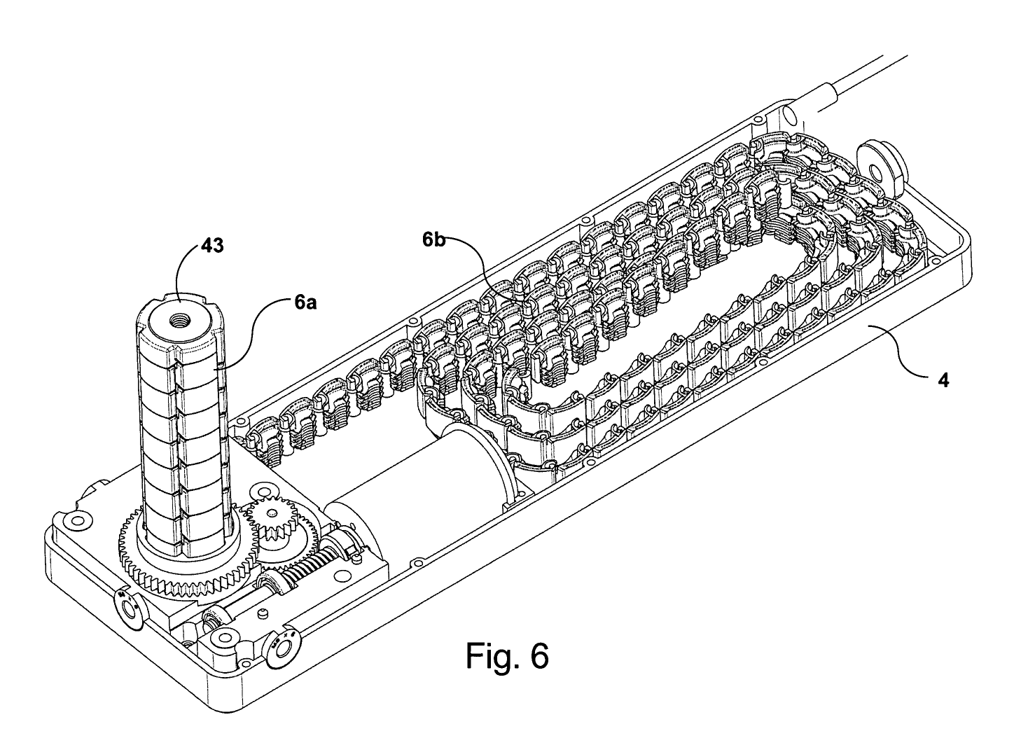

FIG. 6 is a cut open view of the actuator of FIG. 1 in which the chain magazine 8 has been removed for illustration purposes so that the chain 6b is visible and the upper part of the actuator block 7 is being removed to show the transmission. The actuator block 7 and the transmission will be described in greater detail further below. Only the lowest level of the chain 6b in the dual layer chain magazine is shown. In FIG. 6 an end piece 43 for the rod 6a is visible at the free end of the rod 6a. The end piece 43 will be described in further detail below. The actuator rod 6a is provided with five axially extending grooves, but the rod 6a is free of non-axial grooves.

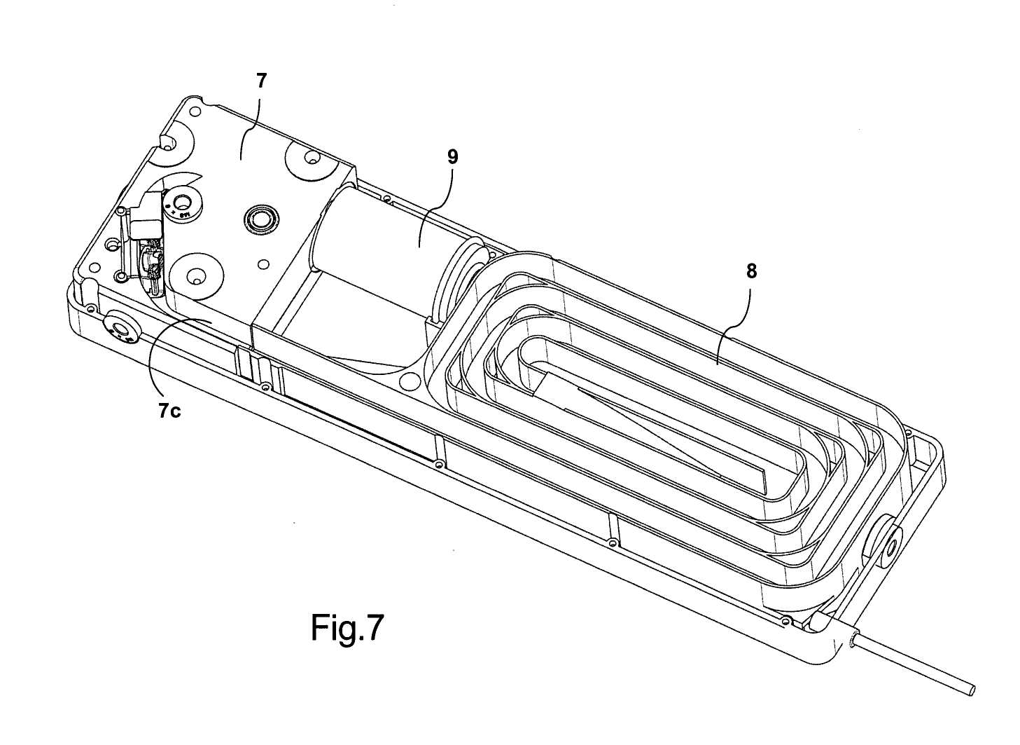

FIG. 7 is a cut open view from the bottom of the actuator with the lower housing shell 4 removed, thereby showing the bottom side of the actuator block 7 and the both side of the electric drive motor 9 and the chain magazine 8. As can be seen this figure the substantially spiral path of the chain magazine 8 connects to a path 7c in the actuator block 7. The chain links 6c are guided in the chain magazine 8 by the upper, lower, and side surfaces of the chain guide without the need for guide rails or guide pins.

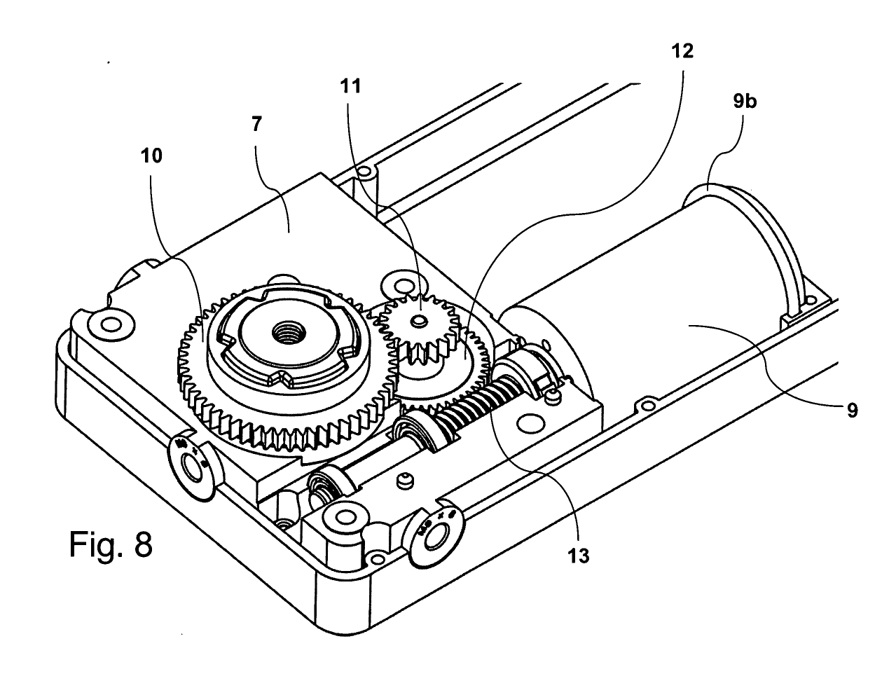

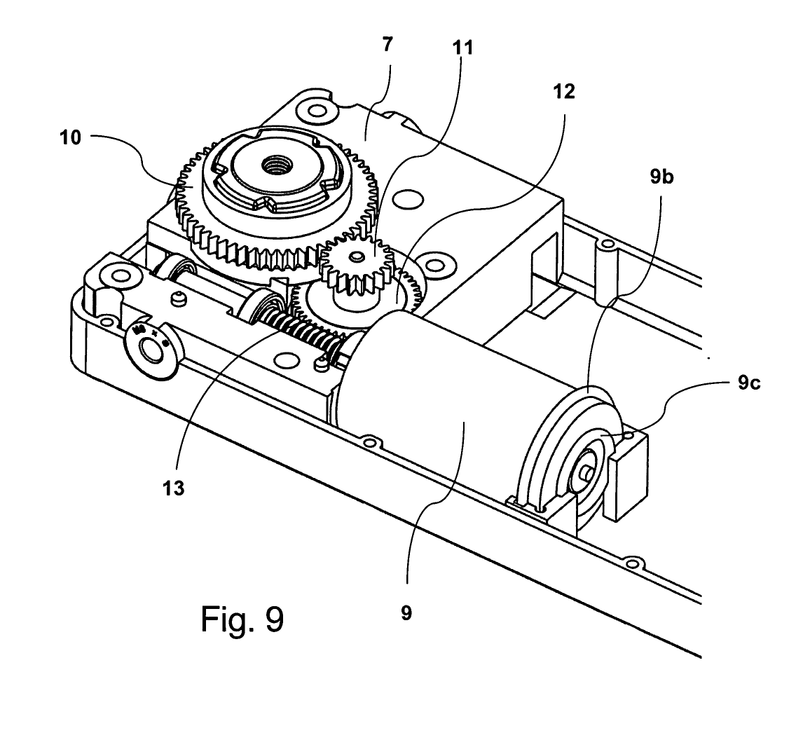

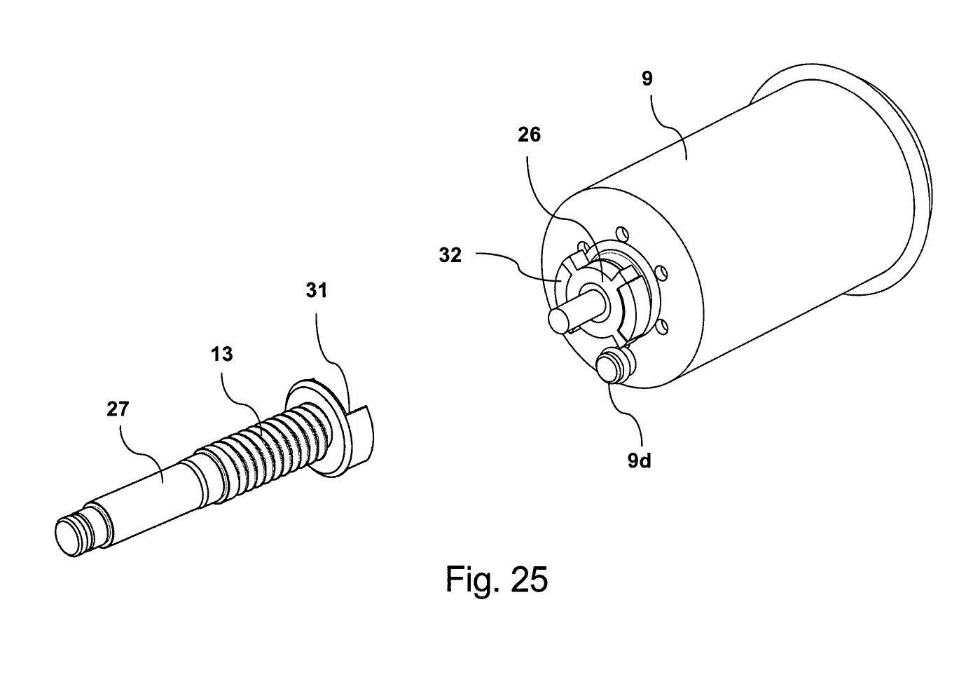

FIGS. 8 and 9 are detailed cut open views of the electric drive motor 9 and the actuator block 7. The rod 6a is received inside a drive ring 10 which engages the plurality of axial grooves in the rod 6a. The drive ring 10 is formed as a gear wheel, which meshes with a gear wheel 11 that is fitted to a shaft that is also fitted with a wormwheel 12. The worm wheel 12 meshes with a worm 13 that is connected to the drive shaft of the electric motor 9 via a coupling that will be described in detail further below. Thus, the transmission is a reduction gear that connects the drive ring 10 to the electric drive motor 9. The electric drive motor 9 is suspended from the housing by a plurality of rubber or elastomeric O-rings 9a, 9b, 9c and 9d (cf. FIG. 25) in order to reduce noise and vibration.

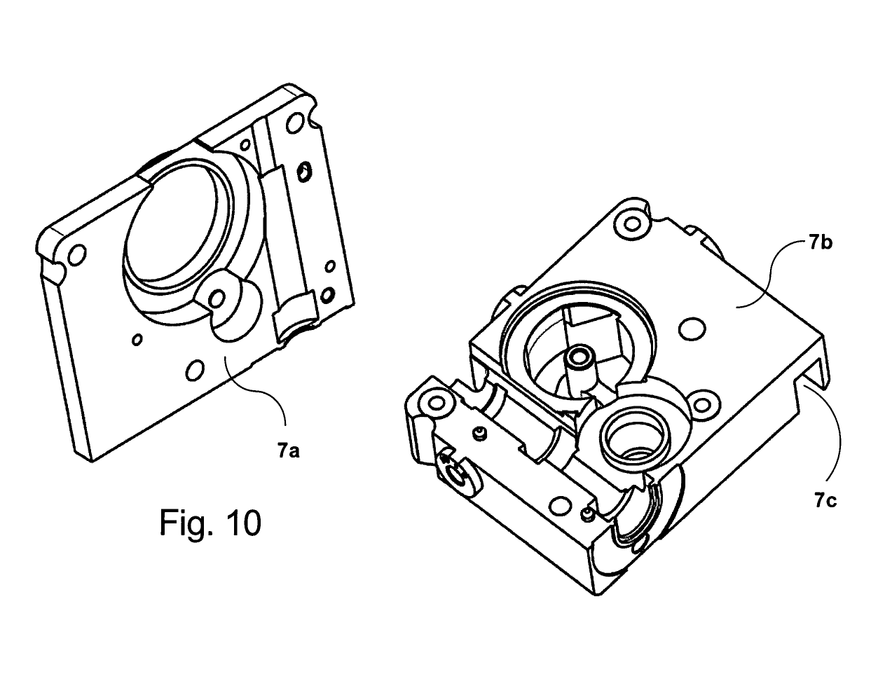

As shown in FIG. 10, the actuator block 7 includes an upper half 7a and a lower half 7b. The halves of the actuator block 7 are made of metal, in one embodiment, a lightweight metal like aluminum and can be made by machining or casting.

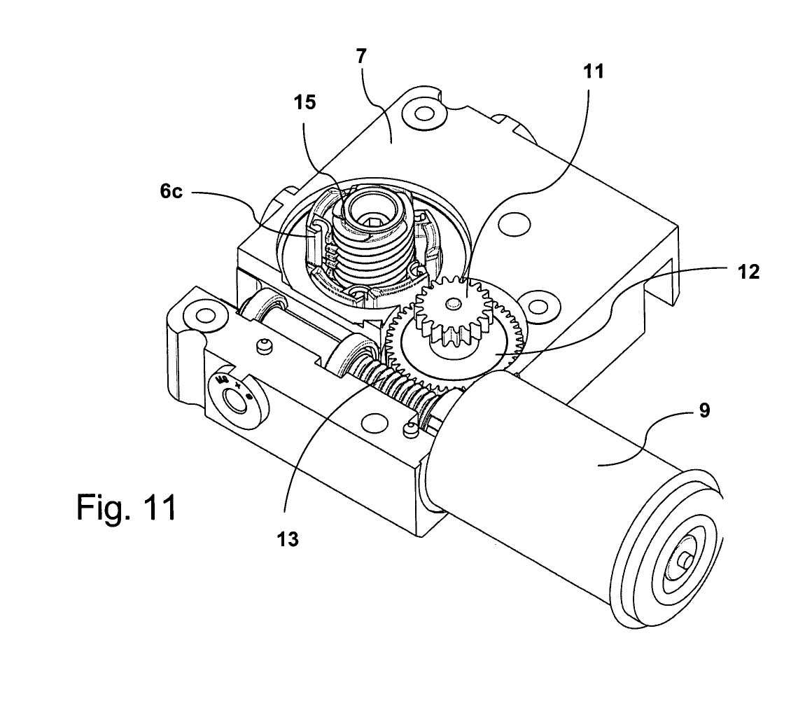

FIG. 11 shows another detailed view of the actuator block 7 with the drive ring 10 removed. Thus, the chain links 6c and a threaded stationary mandrel 15 around which the chain links 6c of the chain 6a are wound had become visible. The circular opening in the actuator block 7 in which the mandrel 15 is received ensures that the chain links 6c assume a circular configuration and are brought into and kept into engagement with the threaded mandrel 15. Thus, the circular opening in the actuator block 7 forms a circular guide for the chain links 6c. Another feature of the mandrel 15 is that it is provided with a switch, so when the top of the rod 6a internally presses the switch inside the mandrel 15, the actuator 1 stops.

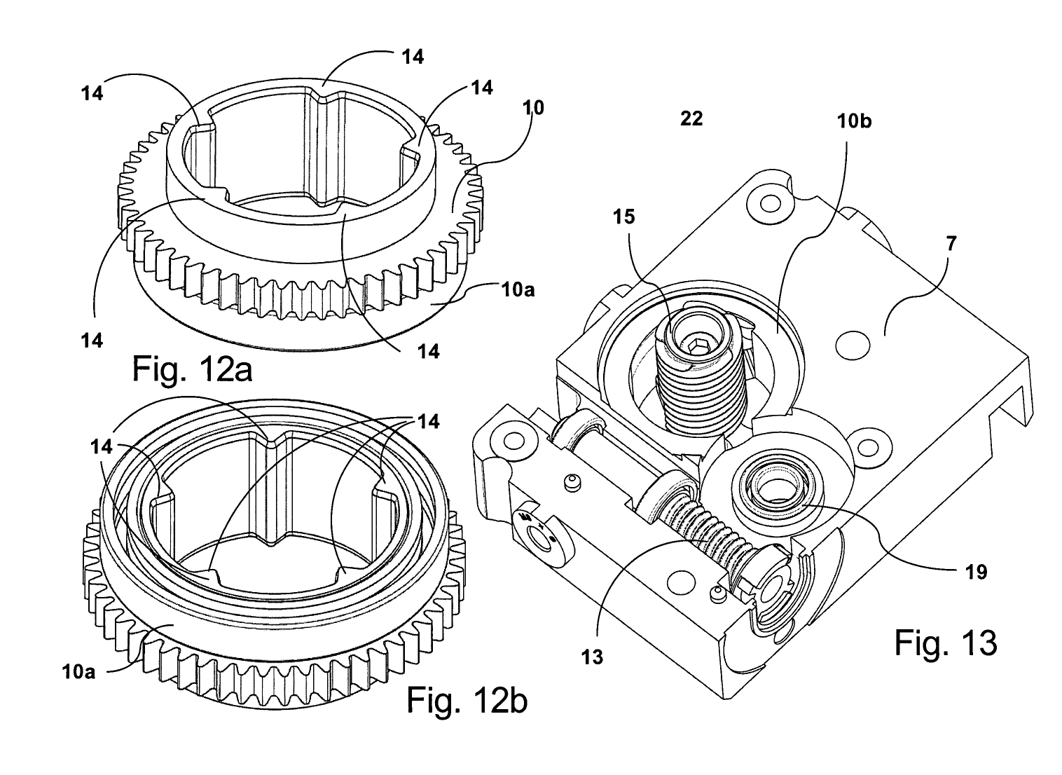

FIGS. 12a and 12b illustrate the drive ring 10 in greater detail. The drive ring and is provided with a plurality (in this case five) internally directed protrusions 14 that are configured for engaging the axial grooves in the rod 6a. The protrusions 14 can (as shown in this embodiment) be axially extending ridges. The drive ring 10 is provided with teeth so that it forms a gear wheel and is supported by a roller bearing 10a. The roller bearing 10a is disposed around the drive ring 10 below the part of the drive ring 10 that forms the gear wheel and therefore, the roller bearing 10a has a large diameter which means that an off-the-shelf roller bearing will have a long life expectancy. Thus, by engaging the rod externally, the axial load can be carried by a large diameter roller bearing and an off-the-shelf roller bearing will provide ample reliability and life expectancy. The load on the bearing 10a is mostly radial, which is a result from the gear wheel engagement. The axial load plus a little axial friction load in the opposite direction from the drive ring is carried by the mandrel 15.

FIG. 13 illustrates the actuator block 7 without the drive ring 10 and without the gear wheel 11 and gear wheel on their common shaft. A recess 10b for receiving the roller bearing 10a and a recess for receiving gear wheel 12 are visible now. In the latter recess a roller bearing 19 for the shaft for the gear wheel 11 and gear wheel 12 is now visible. Further, the stationary threaded mandrel 15 is now better visible since the chain links 6c have been removed for illustration purposes.

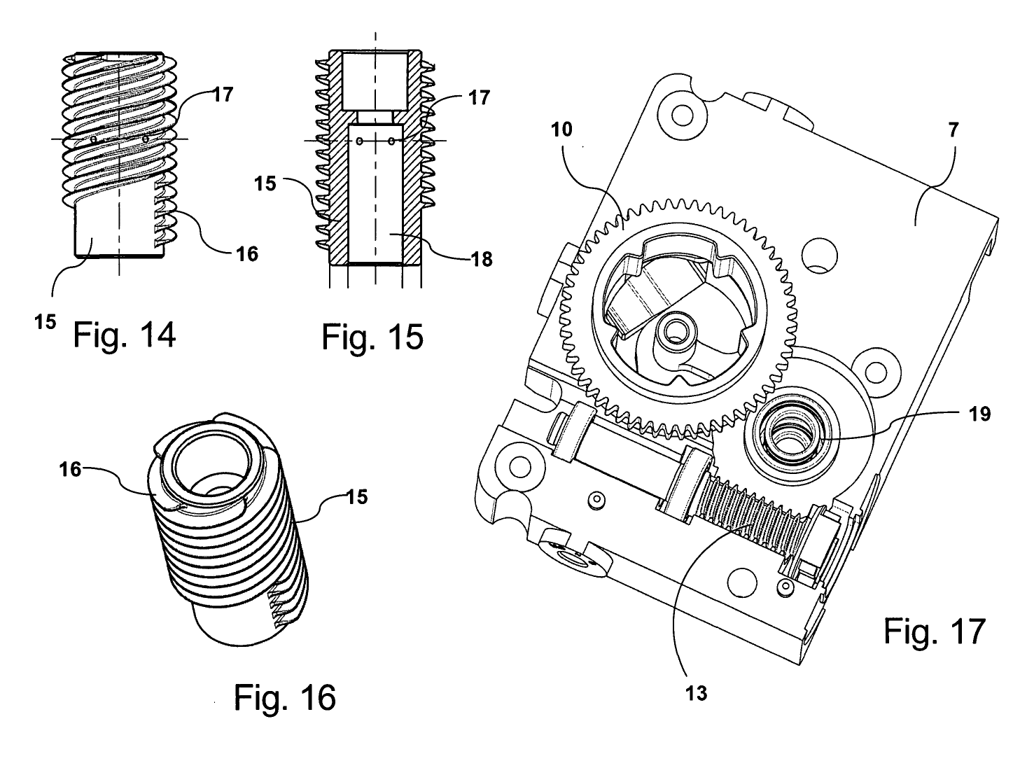

FIGS. 14 through 16 illustrate the stationary threaded mandrel 15 as such. The stationary mandrel 15 is hollow and is provided with a multiple thread 16. In the present embodiment there are five parallel threats. The stationary threaded mandrel 15 is provided with a plurality of lubrication bores 17. In one embodiment, one bore 17 is provided for each thread. The hollow space 18 inside the stationary threaded mandrel 15 is filled with a lubricant that will lubricate the multiple thread 16 during use via the lubrication bores 17.

FIG. 17 illustrates the actuator block 7 without the stationary threaded mandrel 15 for illustration purposes.

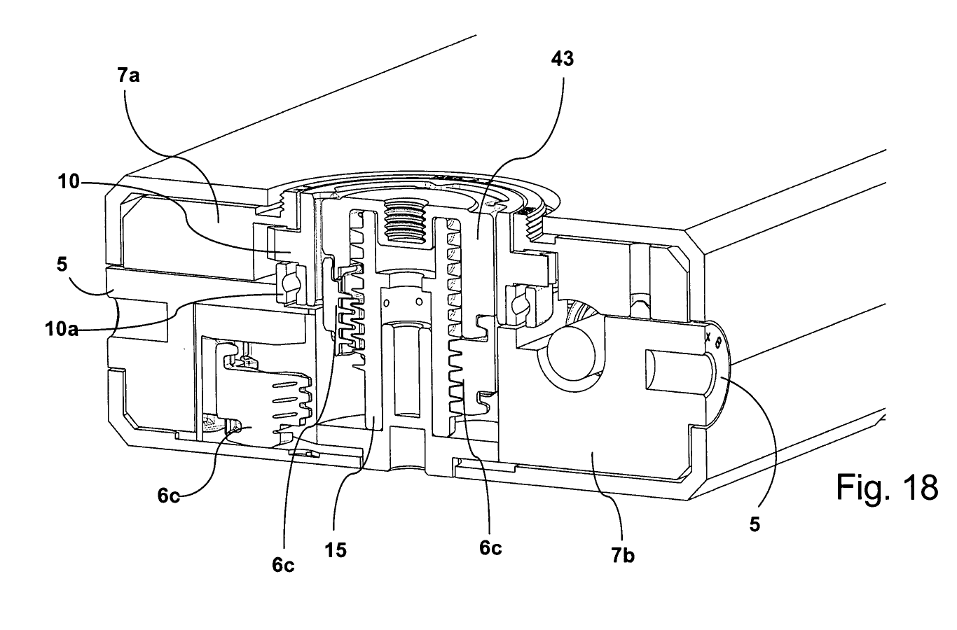

FIG. 18 is a cross-sectional view through the actuator 1 at the center of the actuator block 7. The center of the actuator block 7 forms a winding station for winding of the chain elements 6c into a rod 6a and unwinding the chain elements 6c into a chain 6b.

This figure shows the chain links 6c, the upper half 7a of the actuator block, the lower half 7b of the actuator block, the attachment points and 5, the drive ring 10 and the roller bearing for the drive ring 10a.

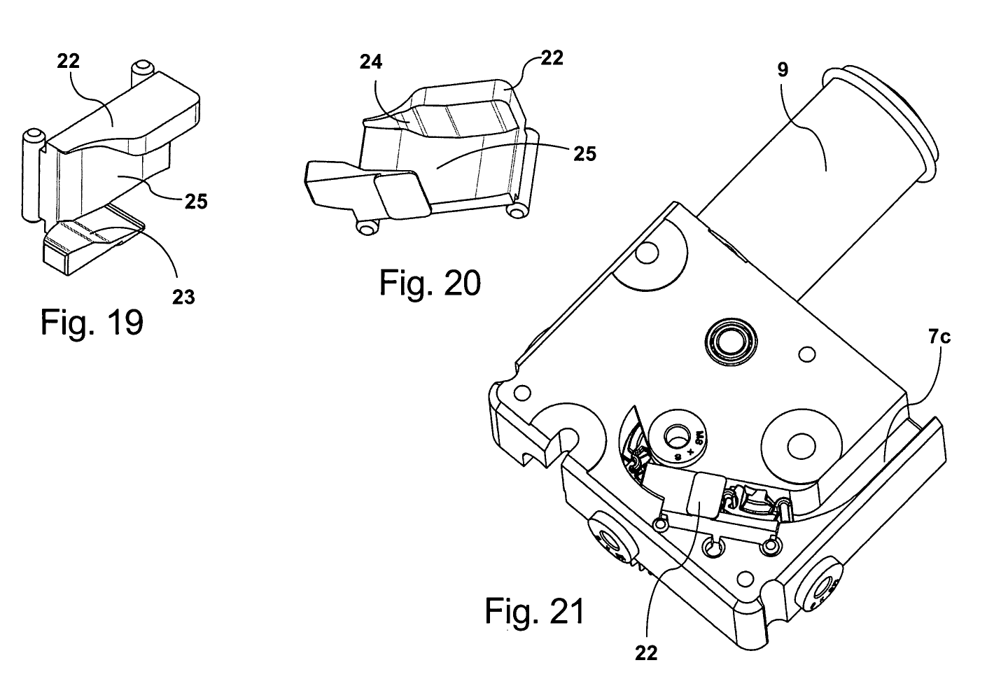

FIGS. 19 and 20 illustrate a slanting chain guide that is provided in the path 7c of the chain inside the actuator block 7 leading up to the winding station, as can be seen in FIG. 21. The slanting chain guide 22 is provided with a lower slanted guide surface 23, an upper slanted guide surface 24 and a sideward guide surface 25. The lower slanted guide surface 23 serves to bring the chain 6b in a slanting arrangement when the chain 6b is moving from the chain magazine 8 towards the winding station with the individual chain elements 6c being offset upwardly relatively to the following chain element 6c when they move from the chain magazine 8 towards the winding station (this process will be described in greater detail for the below). The sideward guide surface 25 is slightly curved and guides the chain 6b in a sideward direction.

The upper slanted guide surface 24 serves to bring the chain 6b in a not-offset “straight” arrangement when the chain 6b is moving from the winding station towards the chain magazine 8 with the individual chain elements 6c forced from being offset upwardly relatively to the following chain element 6c to a straight position when they move from the winding station towards the chain magazine 8 (is this process will be described in greater detail for the below).

In one embodiment, the chain guide 22 is of a hardened material to resist wear and is provided in the chain path 7c just before the winding station. The slanting chain guide 22 guides the chain links 6c from the chain magazine 8 towards the stationary threaded mandrel 15 when winding up the chain into a rod and the chain guide element 22 guides the chain links from the stationary threaded mandrel 15 towards the chain magazine 8 when the chain links 6c are being unwound from a rod 6a into a chain 6b.

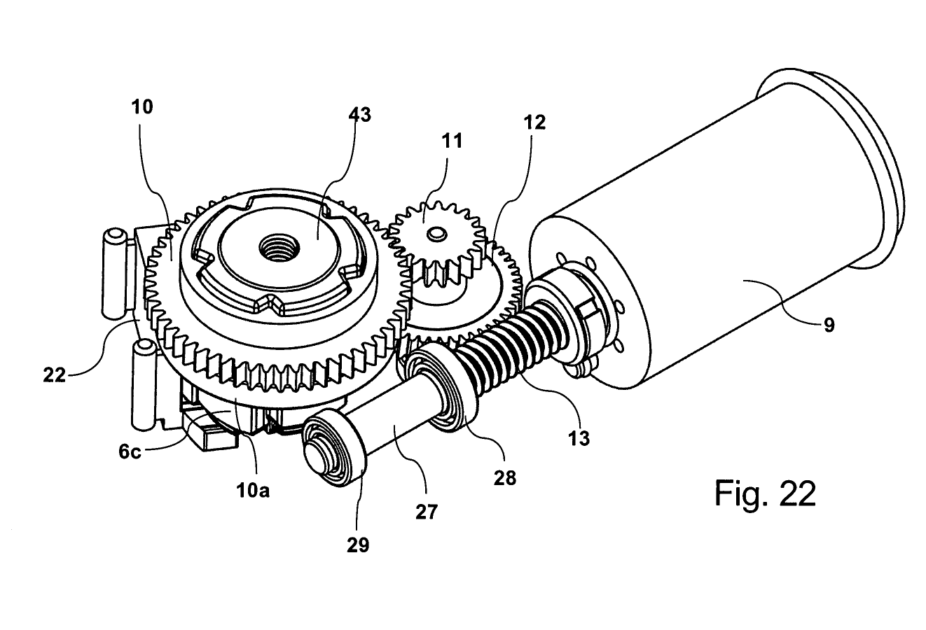

FIG. 22 illustrates the transmission, the electric drive motor 9 the chain links 6c, the drive ring 10 and the guide number 22. The worm 13 is formed on a shaft 27 that is provided with two roller bearings 29 and 28. The roller bearings 29 and 28 bear all the radial and axial forces that act on the shaft 27. Thus, the bearings of the electric drive motor 9 are not exposed to the load of the shaft 27.

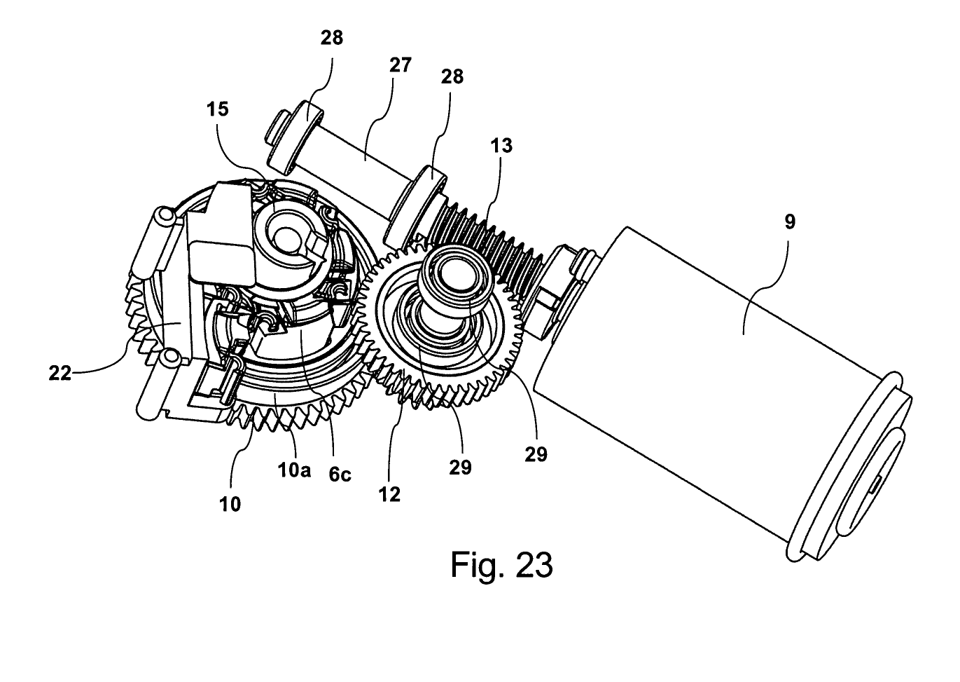

FIG. 23 illustrates the transmission, the electric drive motor 9 the chain links 6c, the drive ring 10 and the slanting chain guide 2 from another angle and now the winding station around the stationary threaded mandrel 15 is better visible. When the drive ring 10 is rotated by the action of the electric drive motor 9 it moves the chain links 6c through the engagement into the axial grooves in the rod 6a between the chain links 6c in accordance with the driving direction. Thereby, the chain links 6c are moved around the stationary threaded mandrel 15 and the engagement between the inner thread of the chain links 6c and the threat 16 on the mandrel causes the chain links 6c to be advanced upwardly or downwardly along the mandrel in the direction of the extension of the rod 6a.

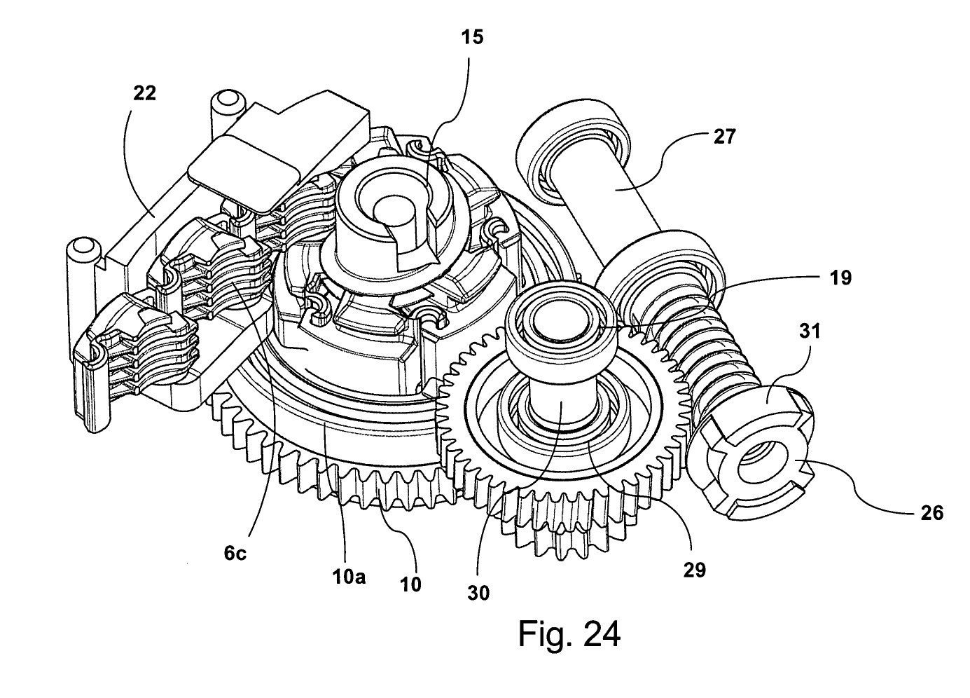

FIG. 24 illustrates the transmission, the chain links 6c, the drive ring 10 and the slanting chain guide 22. The coupling between the shaft 27 and the electric drive motor 9 that includes a coupling member 31 and a rubber element 32 are now visible. Also the common shaft 30 for gearwheel 11 and gearwheel 12 is now clearly visible.

FIG. 25 is an exploded view of the shaft 27 with its coupling 31, the rubber cross-shaped element 32 and the coupling element 26 on the shaft to drive motor 9. This elastic coupling allows relative movement between the electric drive motor 9 and the shaft 27. The rubber element 26 dampens any vibrations and allows for small misalignments. In FIG. 25 a further rubber or elastomeric O-ring 9d is visible. This O-ring 9d is placed on a peg that prevents the electric drive motor 9 from rotating about its axis.

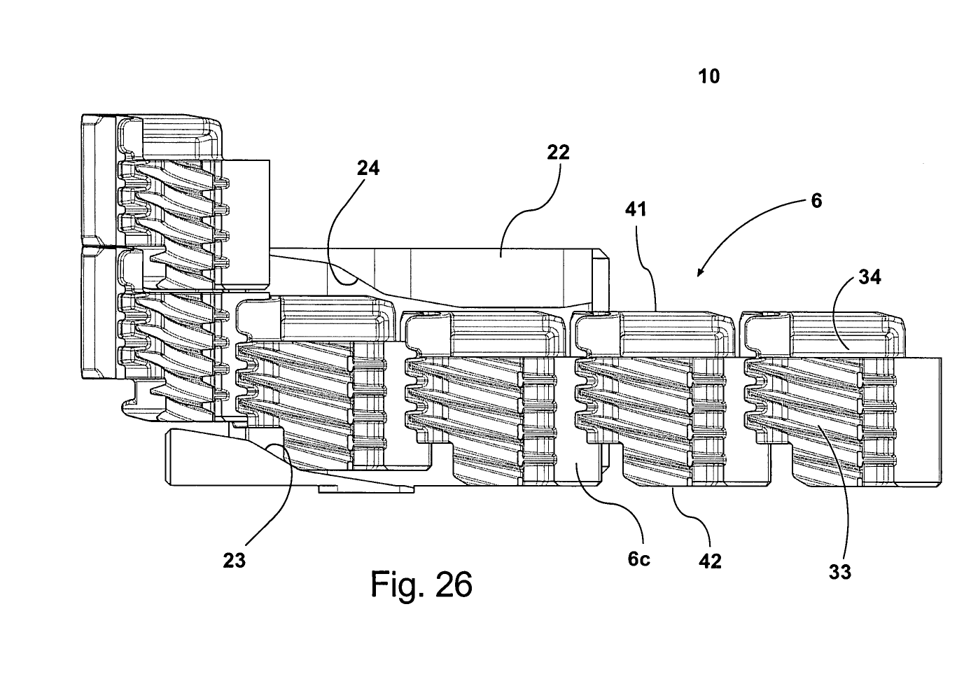

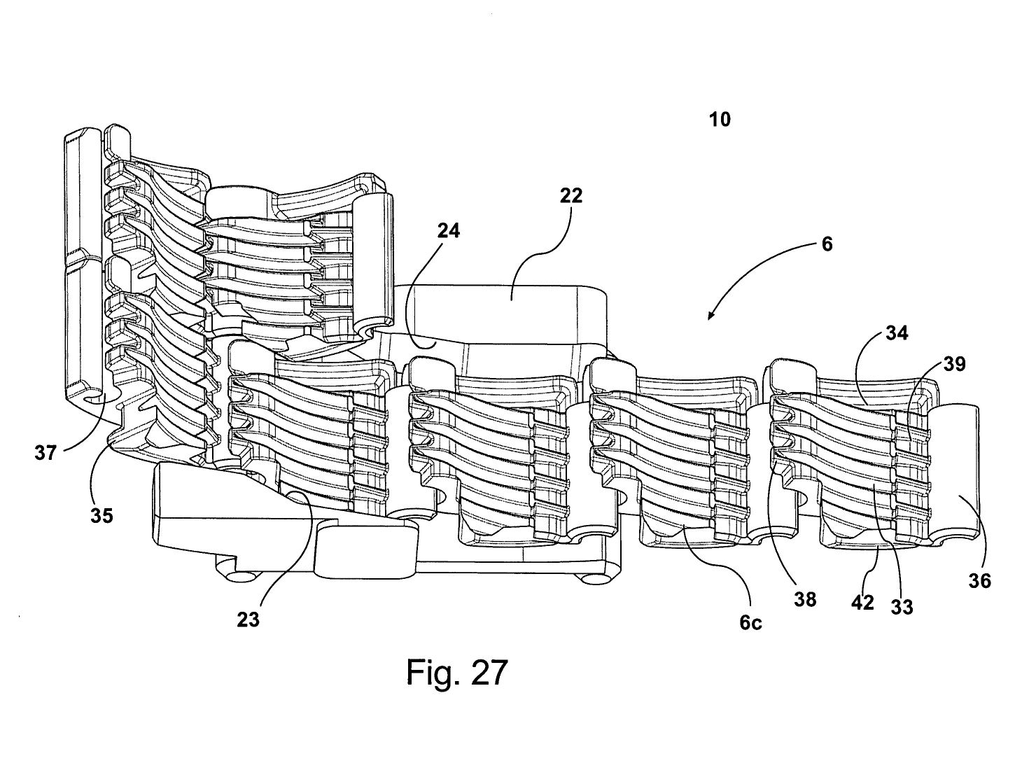

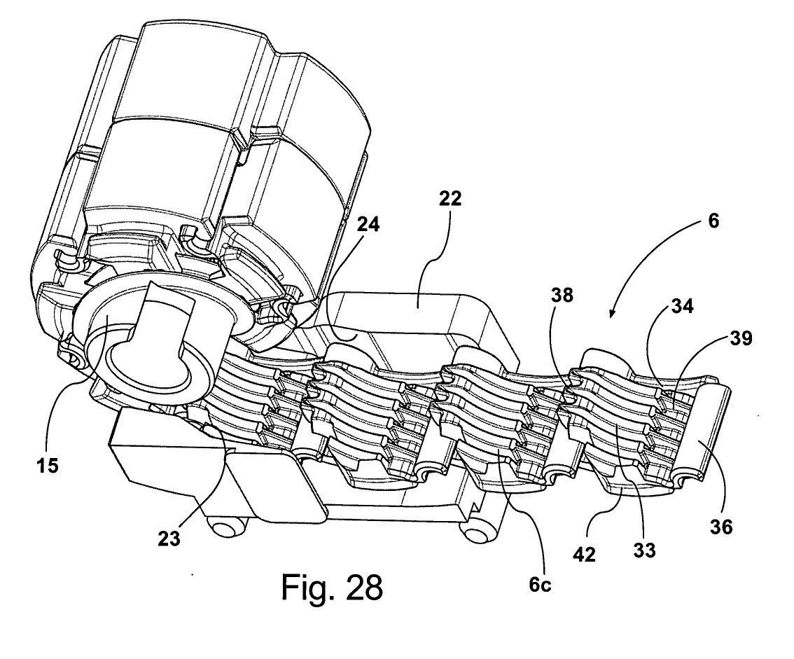

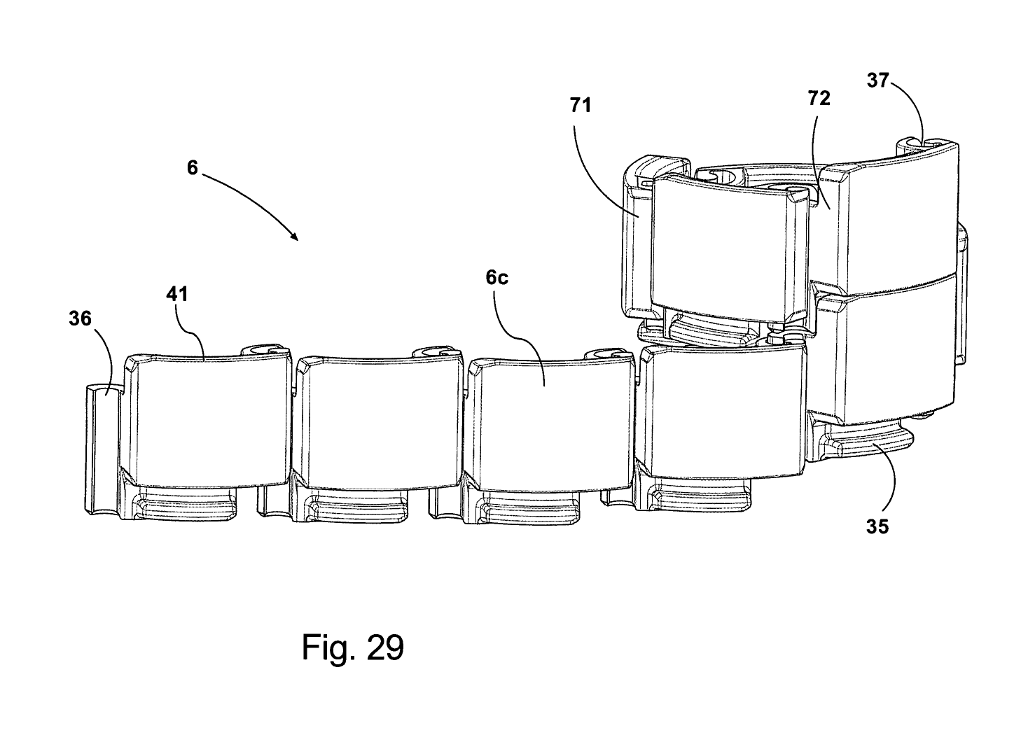

FIGS. 26 through 29 illustrate the winding and unwinding process of the chain into a rod and vice versa in greater detail. The chain links 6c move through the slanting chain guide 22 and when moving towards the winding station, as illustrated in FIG. 26. The chain links 6c have a substantially rectangle outline, that is to say at least the upper surface 41 and the lower surface 42 of the chain links 6c are substantially parallel with the longitudinal extension of the chain 6b and extend substantially traverse to the pivot axes between the chain links 6c and to the longitudinal axis of the rod 6a. When the chain 6b is wound into a rod 6a the lower surface 42 of the chain links 6c engage the lower slanted surface 23, and the chain links 6c are thereby pushed upwards relatively to the following chain link 6c, so that the chain links 6c are upwardly offset relative to the following chain link 6c. During unwinding of the rod 6a into a chain 6b the process is reversed and the upper surface 41 of the chain links 6c engages the upper guide surface 24 and places the chain links 6c in a straight alignment without any offset relatively to one another. In this straight alignment the chain links are stored in each level of the chain magazine 8.

During winding of the chain 6b the length of the spindle rod 6a is increased and the length of the chain 6b is decreased. During unwinding of the rod 6a the length of the spindle rod 6a is decreased and the length of the chain 6b is increased.

By anti-clockwise rotation of the drive ring 10, the chain links 6c are wound, guided by the winding guide 22, circular opening in the actuator block 7 around the stationary mandrel 15, around which the chain links 6c are positioned in closely packed turns under mutual retainment, such that the wound up chain links are prevented from mutual displacement in the winding.

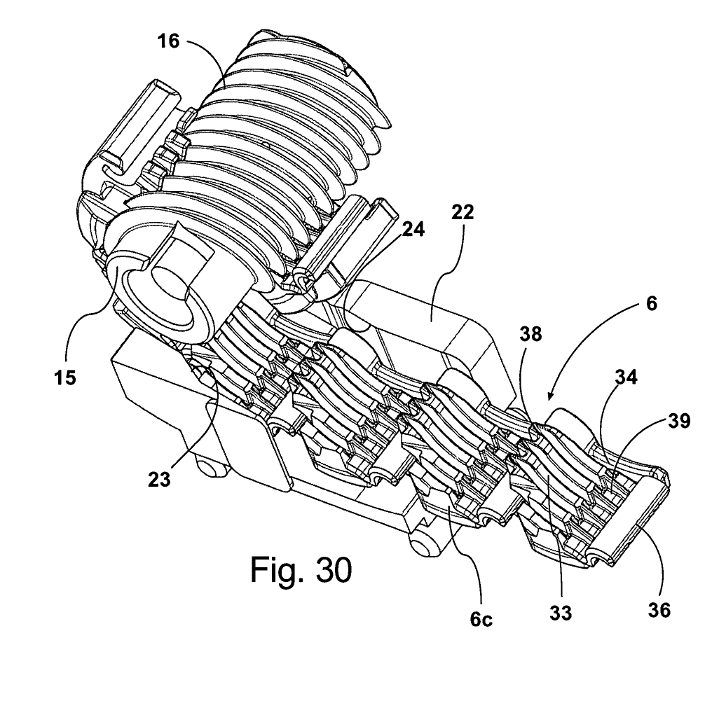

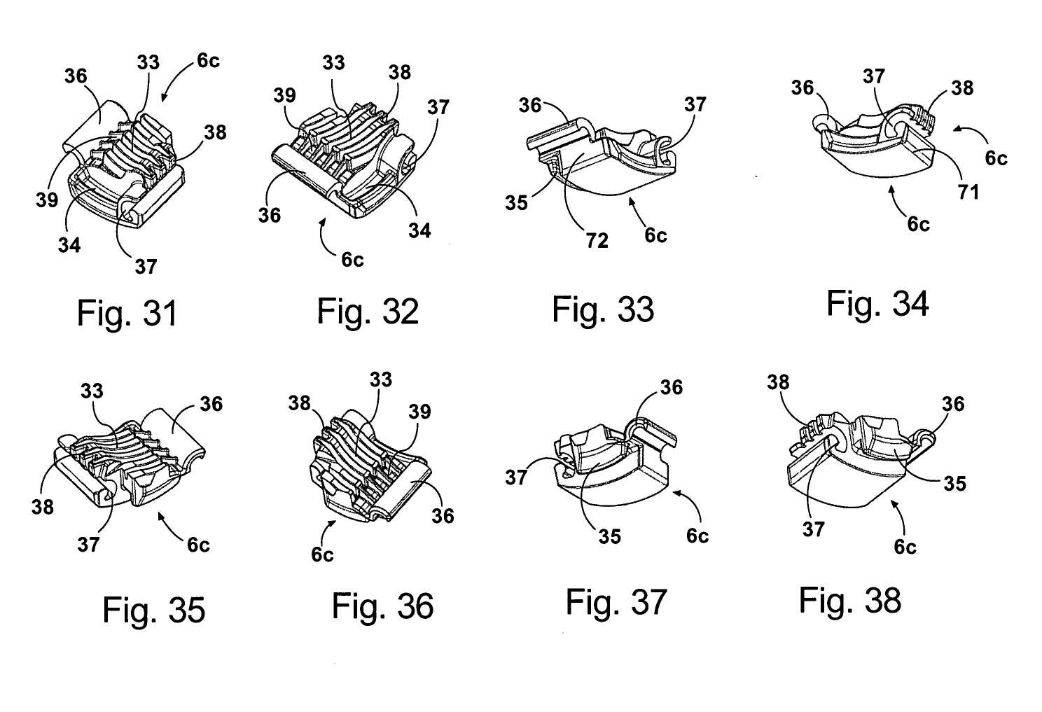

As illustrated in FIGS. 26 through 38, each chain link 6c includes a hook-shaped hinge member 36 and a curved track 37 at opposite sides of the chain link 6c for connecting neighboring chain links to one another. This connection allows the chain links to pivot relative to one another and to be displaced transversely relative to one another. That radially inner side of the chain links 6c is provided with portions of a multiple thread 33 for engaging the thread on the stationary threaded mandrel 15. The portions of thread 33 on the inner side of the chain links 6c form a substantially continuous internal thread inside the rod 6a when the chain links 6c are arranged to form the rod 6a.

Further, the chain links 6c are provided with projecting teeth 38 that engage recesses 39 on neighboring link for locking neighboring links relatively to one another when they are in a bent configuration so that they no longer can be displaced transversely relative to one another.

The chain links 6c are also provided with a substantially straight slot 34 on the radially inner side near the upper surface 41 for engaging a substantially straight engagement ledge 35 of an upwardly neighboring chain links 6c.

The engagement between the respective engagement ledges 35 and slots 34 ensures that the chain links 6c that are positioned one above another in the rod are securely connected to one another and thereby provide stability to the rod 6a.

Further, the first portion of the lower guide surface 23 brings the chain link 6c in their displaced position. The second steeper portion of the lower guide surface 23 pushes the chain link 6c concerned into engagement with a diagonally opposite chain-link 6c. This engagement is created by the upper portion of the hook shaped member 36 being received in the lower portion of the curved track 37 of the diagonally opposite chain-link 6c. The diagonal connection between the chain links 6c greatly improves the stability of the rod 6a. The steep portion of the upper guide surface 24 ensures the disengagement of the diagonal connection between the chain links 6c during unwinding of the rod 6a.

The chain links 6c are provided with end surfaces 71 and 72 that are angled to form part of the axial grooves in the rod 6a when the chain links are wound into a rod. According to another embodiment (not shown but described in greater detail further below) the end surfaces 71 and 72 are angled to touch one another when the chain links are wound into a rod 6a so as to provide a smooth rod without any (axial) grooves.

The chain links 6c have a substantially circular curvature with a convex exterior side and a concave interior side, such that, when wound up, the chain links 6c form a hollow cylinder.

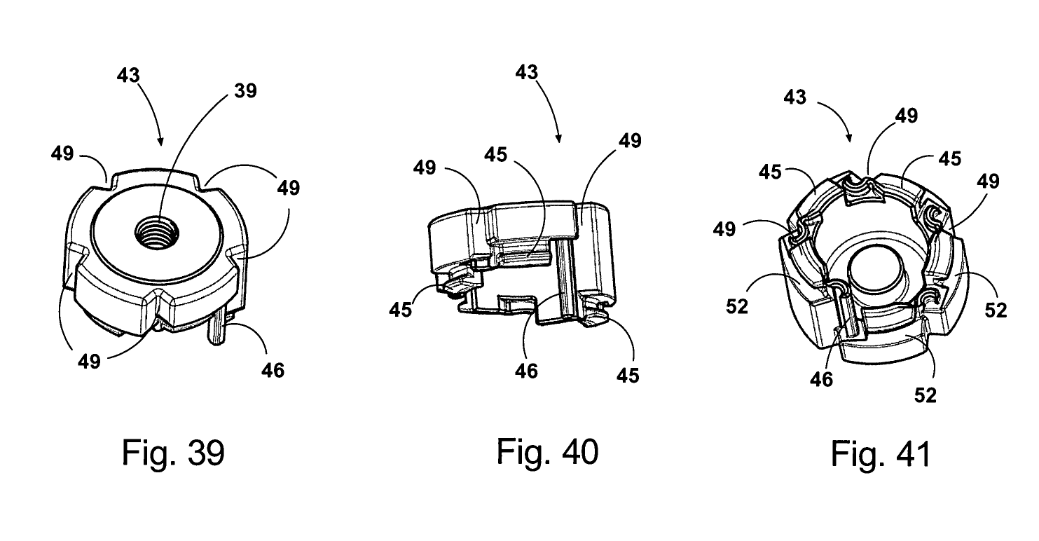

FIGS. 39 to 41 are various elevated views of an end piece 43 for the chain/rod. The end piece 43 forms the top or free extremity of the rod and is configured connect to the first chain link 6c at the extremity of the rod/chain and to engage and interlock with several of the chain links at the extremity of the chain 6a. For connection to an object to be actuated (not shown) the end piece 43 is provided and end surface to from the top of the rod 6a. The end surface is provided with a internally threaded recess 39.

The end piece 43 is provided with a connection member 46 in the form of a hook-shaped hinge member for connecting to the curved track 37 of the first chain link 6c at the extremity of the chain 6b and a spiral (not shown) or circular and stepped axially directed engagement surfaces 52 for engaging the upper sides 41 of several of the chain links 6c at the extremity of the chain. The end piece 43 is also provided with several engagement ledges 45 for engaging the straight slots 34 of several of the chain links 6c at the end of the chain/rod. Further, the end piece 43 is provided with five axial grooves 49 so that the end piece 43 can be received in the drive ring 10 and be countersunk, as shown in e.g. FIGS. 1,5 and 8.

FIGS. 43 through 44 illustrate a swivel 60 for providing a swiveling connection between an object to be moved by the actuating rod 6a. The swivel 60 comprises a rotatably suspended body part 61 with attachment members 62. A roller bearing 63 and a stationary body part 64. The stationary part 64 is secured to the end piece 43 by means of a bold 65 that engages the threaded recess 39 in the end piece 43. The roller bearing 63 is secured relative to the stationary part 64 by a rim 68 at the top of the stationary part 64 and a simmering 67. The roller bearing 63 is secured relative to the rotatably suspended body part 61 by a rim 69 at the bottom of the rotatably suspended body part 61 and by a simmering 66 at the top of the rotatably suspended body part 61.

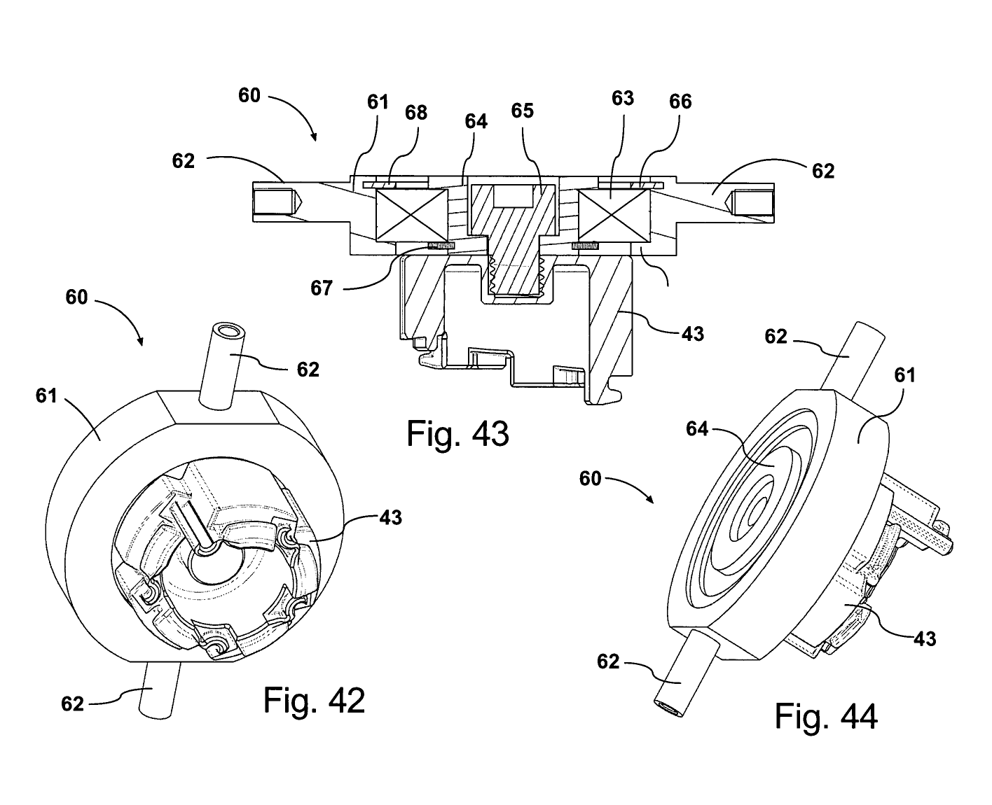

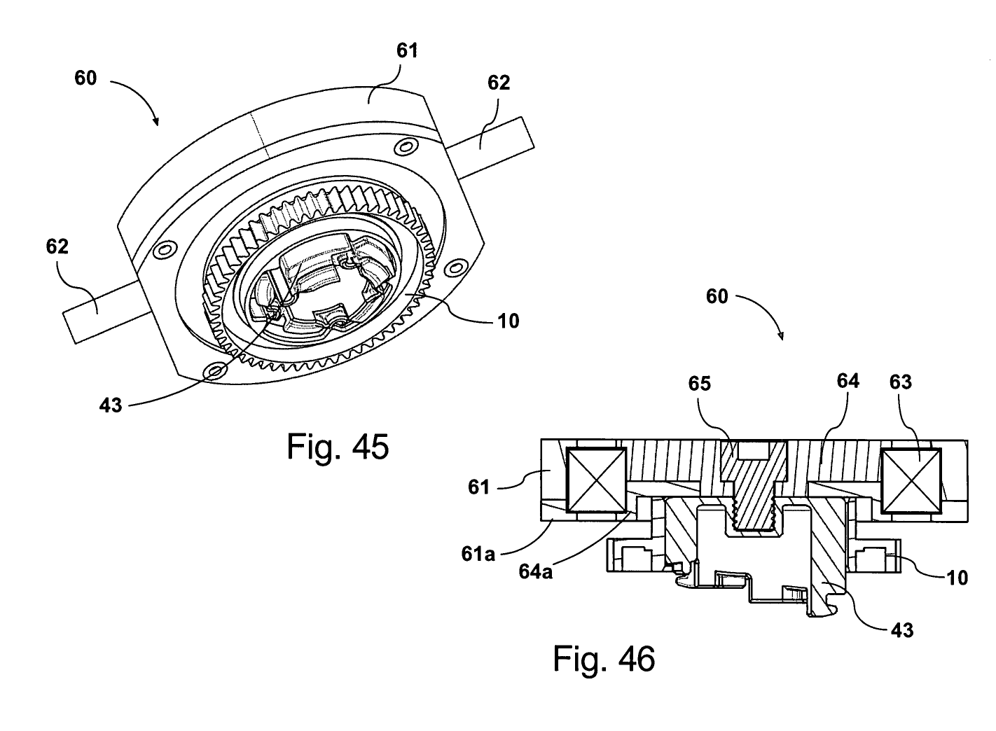

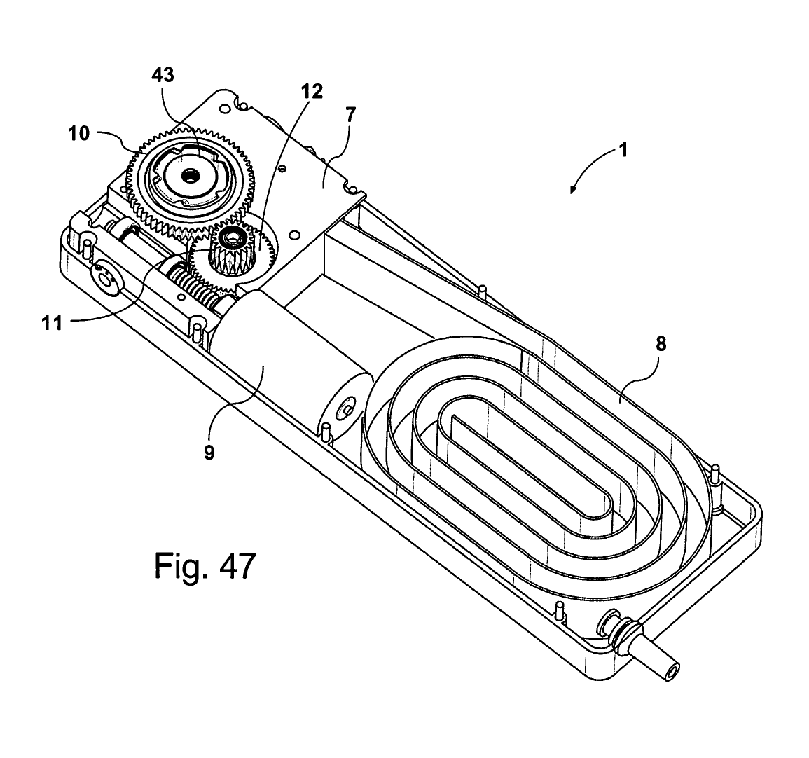

FIGS. 45 and 46 illustrate another embodiment of the swivel 60, which is essentially identical to the swivel shown in FIGS. 42 to 44, except that the rotatably suspended body part 61 comprises a further body part 61a. These two body parts are each provided with rims for engaging the upper and lower side of the bearing 63, respectively. Also the stationary body part 64 is provided with a further body part 64a, and both 40 parts are provided with rims for engaging the upper and lower side of the bearing 63, respectively.

In yet another embodiment (not shown) is the swivel is an integral part of the end piece 43.

FIG. 47 illustrates another embodiment of the actuator 1. The actuator according to this embodiment is essentially identical with the actuator describes above, except that the chain magazine 8 is not of a split level and comprises only one level. Further, due to the lower building height of the chain magazine, the overall height of the actuator one can be reduced. The effect of this can be seen on the construction of the gear wheels 11 and 12 that are this embodiment more closely spaced. Thus, this embodiment will have a lower building height, but at the same time a reduced stroke since less chain 6b can be stored in the chain magazine 8. Further, in this embodiment the chain 8 magazine has been constructed so as to avoid any sharp and recurring bends in the magazine. As can be seen in FIG. 47, the chain magazine 8 is substantially formed as a flattened spiral. Thus, during transport through the chain magazine the chain 6b needs to be less often forced from a bend to a straight configuration and vice versa, thereby reducing the amount of friction and energy required to move the chain into and out of the chain magazine 8.

According to another embodiment (not shown) the chain magazine is rotating, and the chain is wound up like in a reel. This embodiment reduces the friction caused by urging the chain to a chain, in a chain magazine.

According to another embodiment (not shown) the chain is stored in a helix shaped container, e.g. in an application for a lifting column.

According to an embodiment (not shown) the actuator 1 is provided with and end of stoke limiter. The end of stroke limits includes a reed relay to get the signal from chain links 6c that are provided with a magnet or are magnetized themselves. The reed relay is coupled to a electronic control unit of the actuator (not shown) that cuts power to the electric drive motor when the respective magnet or magnetized chain-link 6c passes the reed relay. Thus, there will be provided a magnet or magnetized chain link 6c near both extremities of the chain 6b so as to provide an end stop for the outward and inward stoke of the actuator. Alternatively, a mechanical switch can be used as the chain stop.

The links 6c of the chain 6b according to the aspects of the disclosed embodiments can be made from various materials. Examples of suitable materials are technical plastics such as IXEF, Glass filled IXEF, POM etc. In principle all moldable types of plastic can be used, but the stronger types are preferred. The same applies to metals: all metals that can be cast can be used, but the stronger ones are preferred, such as zinc, magnesium, aluminum, cast iron, all types of MIM (metal injection molding), where the MIM starts with a mixture of plastic or other filler material and metal and the filler material is burned off afterwards so that a solid cast metal item is created. Further, polyzinc can be used.

According to another embodiment (not shown) the circumference of the rod is a pentagon or polygon of a higher order. In this embodiment of the inner outline of the drive ring has a corresponding polygon shape.

According to another embodiment (not shown) is the chance mission does not include a worm and a worm wheel but includes a spiroid or helical gearing instead.

According to another embodiment (not shown) the segments are shaped in such a way so that a regular external thread is provided when assembled. In this embodiment the drive is like in a conventional spindle-based actuator.

According to another embodiment (not shown) the rod has a circular circumference to form a substantially prefect cylinder. In this embodiment the rod is hollow and provided with a double internal thread. One of the threads being configured to engage a concentric stationary threaded mandrel at the base of the rod and the other thread is configured steeper and configured to engage a concentric drive wheel. A drive shaft for the drive wheel extends through the static mandrel.

The principle of winding and interlocking and unwinding and unlocking the chain elements to transform between rod and chain is essentially the same as in WO 99/53221 which is hereby incorporated by reference.

The actuator according to one embodiment finds use in wheelchairs for raising and lowering seats, in kitchens for raising and lowering kitchen units to provide a variable height kitchen (worktop), in theaters and the like for raising and lowering floors, such as theater stage floors. The actuator finds also use in cars as a jack. Further, the actuator finds use in mobile homes and the like as stabilizing legs with the actuator in build in the mobile home and the rod of the actuator serving as a stabilizing leg when the mobile home is parked. For this purpose a mobile home could be provided with four actuators disposed near the corners of the floor of the mobile home, and with the four actuator roads being extended the mobile home would actually be standing on the rods and thereby stabilized.

A wheelchair (not shown) with an actuator as described above, the actuator being disposed under the seat of the wheelchair and configured to raise and lower the seat of the wheelchair.

A kitchen unit (not shown) with a worktop supported by a plurality of cabinets and two or more actuators comprising a plurality of chain links that can be wound up to transform a chain of said links into a stable elongate rod protruding from the actuator and can be unwound to transform said elongate rod into a flexible chain that is received in a chain magazine. The actuators are configured to raise and lower the kitchen unit.

A floor (not shown) supported by a plurality of actuators comprising a plurality of chain links that can be wound up to transform a chain of said links into a stable elongate rod protruding from the actuator and can be unwound to transform said elongate rod into a flexible chain that is received in a chain magazine. The actuators are configured to raise and lower the floor. The floor can be a theater floor or stage floor. Alternatively, the

could be the seat of chair for elderly people with a catapult seat that raises and tilts in one go. Hereto, the actuator can be combined with various tilt and lifting mechanisms, such as scissor mechanisms.

Generally, the actuator incorporating aspects of the disclosed embodiments can be combined with any kind of known mechanisms to guide and stabilize an object to be moved. These can be link mechanisms including pivoting and/or sliding links in any desired combination.

According to one embodiment, the chain can be used to create rods and internally or externally threaded spindles wound up of chain links. This method includes assembling the chain and winding it into the desired length of rod. Thereafter, the chain links are permanently bonded/connected so as to provide a solid and stable rod or spindle. The chain links can be permanently bonded/connected by various methods. One method is to apply adhesive. Another method is to apply fusion or welding. Yet another method is to apply braising.

The various aspects of what is described above can be used alone or in various combinations. It should be noted that the teaching of this application is not limited to the uses indicated above that are merely exemplary.

The teaching of this application has numerous advantages. Different embodiments or implementations may yield one or more of the following advantages. It should be noted that this is not an exhaustive list and there may be other advantages which are not described herein. One advantage of the teaching of this application is that the actuator can be constructed without the need for especially high-performing roller bearings. Another advantage is that it provides for an actuator that can provide for a rod without external thread. A further advantage of this application is that it provides for a very compact and reliable actuator. Yet another advantage is that it provides for a smooth and silent actuator. Further advantage is that it provides for means to connect the rod of the actuator 8 with a non-rotating object. Another advantage is that it provides for less complicated chain elements.

Although the teaching of this application has been described in detail for purpose of illustration, it is understood that such detail is solely for that purpose, and variations can be made therein by those skilled in the art without departing from the scope of the teaching of this application.

For example, although the teaching of this application has been described in terms of a rectangular shaped actuator, it should be appreciated that the aspects of the disclosed embodiments may also be applied to other housing shapes, such as disk or oval shaped housings and the like with different heights

It should also be noted that there are many alternative ways of implementing the methods and apparatuses of the teaching of this application.

The term “comprising” as used in the claims does not exclude other elements or steps. The term “a” or “an” as used in the claims does not exclude a plurality. The single processor or other unit may fulfill the functions of several means recited in the claims.

What is claimed is:

1. An actuator comprising a plurality of chain links that can be wound up to transform a chain of said links into a stable elongated rod protruding from the actuator and can be unwound to transform said elongated rod into a chain that is received in a chain magazine, said elongated rod having a non-circular circumference, and said actuator being configured to engage said non-circular circumference to impart rotation on said rod.

2. An actuator according to claim 1, further comprising a drive ring shaped and dimensioned to engage the non-circular circumference of the rod.

3. An actuator according to claim 1, wherein said non-circular circumference is a substantially circular circumference interrupted by axially extending grooves in the rod.

4. An actuator according to claim 2, wherein said drive ring is provided with radially distributed inwardly projecting protrusions shaped and dimensioned to engage the axial grooves of said rod.

5. An actuator according to claim 1, wherein the base of said elongated rod is received inside said drive ring.

6. An actuator according to claim 5, wherein said drive ring is supported by a bearing that surrounds the base of said rod.

7. An actuator according to claim 1, wherein said rod is a hollow internally threaded rod and said actuator comprises a stationary externally threaded mandrel around which said chain elements rotate in one direction to engage to form the rod and rotate in a second opposite rotation to disengage to form the chain.

8. An actuator according to claim 7, wherein the side of the chain elements that form the inner surface of said rod is provided with thread that engages the externally threaded mandrel at the base of the rod.

9. An actuator according to claim 8, wherein the engagement of the external thread of the mandrels with the internal thread of the chain elements at the base of the rod causes axial movement of the rod when the rod is rotated.

10. An actuator according to claim 2, wherein the radially outer surface of said drive ring is toothed so that the drive ring forms a gearwheel.

11. (canceled)

12. (canceled)

13. An actuator comprising a plurality of chain links that can be wound up to transform a chain of said links into a stable elongate hollow internally threaded rod protruding from the actuator and can be unwound to transform said elongate rod into a chain that is received in a chain magazine, wherein said actuator comprises a stationary externally threaded mandrel around which said chain elements rotate in one direction to engage to form the rod and rotate in a second opposite rotation to disengage to form the chain.

14. (canceled)

15. (canceled)

16. (canceled)

17. An actuator according to claim 13, wherein said chain is made of a polymer material, preferably in engineering plastic and said externally threaded mandrel is made of a metal, preferably steel.

18. An actuator according to claim 13, wherein the inner side of the chain links is provided with portions of a thread that is configured to engage the tread on the stationary threaded mandrel.

19. An actuator according to claim 18, wherein said portions of thread on the inner side of the chain links form a substantially continuous thread when the chain links are arranged to form the rod.

20. (canceled)

21. (canceled)

22. An actuator comprising a plurality of chain links that can be wound up to transform a chain of said links into a stable elongate rod protruding from the actuator and can be unwound to transform said elongated rod into a chain that is received in a chain magazine, wherein said chain links are guided in a winding station that includes a slanting guide member provided with a slanting lower guide surface that engages the underside said chain links to displace the chain links relative to the subsequent chain links so that the chain adopts a slanted configuration during winding just before the chain links engage a circular guide that ensures that the chain adopts a circular and slanted or so called helical configuration.

23. An actuator according to claim 22, wherein said slanting guide member is provided with a slanting upper guide surface that engages the upper side of said chain links just after they exit the circular guide during unwinding to ensure that the chain links adopt a non-slanting configuration in the chain magazine.

24. (canceled)

25. (canceled)

26. (canceled)

27. (canceled)

28. (canceled)

29. (canceled)

30. (canceled)

31. (canceled)

32. A chain that comprises plurality of chain links that can be wound up and interlocked to transform the chain into a stable elongate rod and can be unwound to transform said elongate rod into a flexible chain, wherein said chain links having a substantially rectangular outline when viewed in a radial direction of the rod.

33. A chain according to claim 32, wherein neighboring chain links are arranged displaced relative to one another when the chain is wound to form a rod and wherein said chain neighboring chain links are aligned when they are received in a planar chain magazine.

34. A chain according to claim 33, wherein the chain links form a circular and stepped arrangement then they are wound and interlocked to form the elongated rod.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. A method for winding and unwinding a chain that comprises plurality of chain links that can be wound up and interlocked to transform the chain into a stable elongate rod and can be unwound to transform said elongate rod into a flexible chain, said method comprising:
winding or unwinding said chain elements about a short externally threaded stationary mandrel by engaging the outer surface of the rod and applying torque to the rod to impart rotation and thereby wind or unwind the chain.

48. (canceled)

49. (canceled)

50. (canceled)

51. (canceled)

52. (canceled)

53. (canceled)

54. (canceled)

55. (canceled)

56. (canceled)

57. (canceled)

58. (canceled)
